(19) United States
(12) Patent Application Publication
(10) Pub. No.: US 2007/0026897 A1
(43) Pub. Date: Feb. 1, 2007

(54) System and method for use in wireless communication employing antenna network

(75) Inventors: John S. Nantz, Brighton, MI (US); Thomas J. LeMense, Farmington, MI (US); Riad Ghabra, Dearborn Heights, MI (US); Yi Luo, Ypsilant, MI (US); Tom O. Tang, Novi, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/189,361

(22) Filed: Jul. 26, 2005

(51) Int. Cl. H04M 1/00

(52) U.S. Cl. 455/562.1

(57) ABSTRACT

A system and method for use in wireless communication includes connecting a communication circuit to an antenna network. The network includes multiple antennas, each antenna optimized for operation in one of multiple designated frequency bands.

### CROSS-REFERENCE TO RELATED APPLICATION

The present application is related to U.S. patent application Ser. No. __/______, entitled “System And Method For Use In Wireless Communication Employing Multiple Antennas,” attorney docket LEAR 05790 PUS, which was filed on the same day as the present application and which is hereby incorporated by reference.

### TECHNICAL FIELD

The following relates to a system and method for use in wireless communication employing an antenna network.

A detailed description and accompanying drawings are set forth below.

### BRIEF DESCRIPTION OF THE DRAWINGS

FIG. 1 is a block diagram depicting one embodiment of the system and method described herein; and

FIG. 2 is a block diagram depicting another embodiment of the system and method described herein.

### DETAILED DESCRIPTION

With reference to the Figure, a more detailed description of the system, method and device will now be provided. It is increasingly common in automotive vehicles to use wireless communication systems for a variety of applications. These include, but are not limited to, remote keyless entry (RKE), tire pressure monitoring (TPM), interfacing with garage door opening (GDO) systems, vehicle immobilzation, voice activated controls, and others.

Many of these existing communication systems, whether they include a transmitters, receiver, or transceiver, are designed to operate in multiple frequency bands, or to perform pattern optimization within a fixed frequency band. As a result, such communication systems require either multiple antennas with multiple switches in a switching network, or a single antenna with variable components, such as a veractor diode, in order to tune that antenna to various frequencies. This leads to the further requirement of microprocessor control of the switching network or variable components, and may include the need for intelligent software.

Thus, there exists a need for a system and method for use in a communication system, such as for automotive applications including RKE, TPM, remote control of GDO systems, vehicle immobilization, voice activated controls, and the like, that allows for using multiple antennas simultaneously without the need for switching or tuning. That is, such a system and method would employ an antenna network with multiple antennas optimized for designated frequency bands, pattern optimization and/or polarization without the need for either switching or tuning circuitry or components.

Referring now more specifically to the Figures, block diagrams of two embodiments of the system and method described herein is shown, denoted generally by reference numerals 10 and 10′. In general terms, the system and method provide an antenna concept for use in multi-frequency applications, particularly automotive applications such as RKE, TPM, remote control of GDO systems, vehicle immobilization, voice activated controls, or the like. The system and method allow for the use of a single transmitter, receiver or transceiver circuit for multiple frequency operating requirements (although more than one transmitter, receiver or transceiver circuits could also be used). The system and method employ multiple antennas for optimizing performance in different frequency bands.

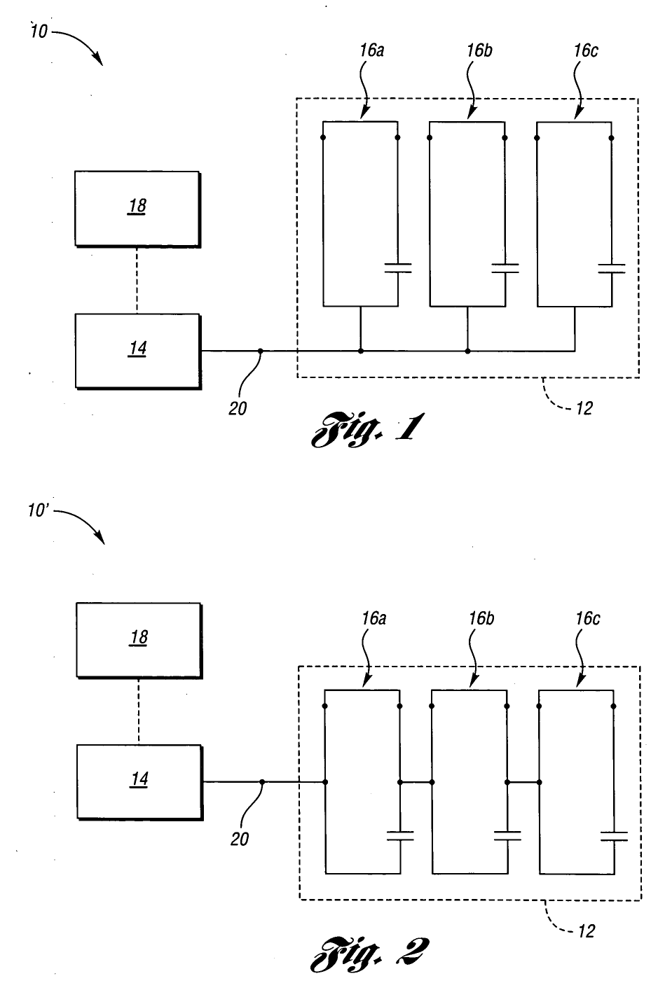

As seen in FIGS. 1 and 2, the system and method (10, 10′) include a communication circuit (14) connected to an antenna network (12). Network (12) includes a plurality of antennas (16a, 16b, 16c). For simplicity, FIGS. 1 and 2 show three antennas (16a, 16b, 16c), although there is no limit to the number of antennas that could be used.

In the embodiment of FIG. 1, antennas (16a, 16b, 16c) are connected in parallel. Alternatively, however, as shown in the embodiment of FIG. 2, antennas (16a, 16b, 16c) may be connected in series. It should also be noted that antennas (16a, 16b, 16c) may be of any type or combination of types Bincluding, but not limited to, loop, monopole, or others.

Depending upon the desired application, communication circuit (14) may be a transmitter, receiver or transceiver, and may include appropriate matching circuitry. As can be seen in FIGS. 1 and 2, there is a single feedpoint (20) to the antenna network (12). Each of the antennas (16a, 16b, 16c) is optimized for a specific frequency band of operation. Any frequency presented to the input feedpoint (20) of antenna network (12) radiates out the antenna (16a, 16b, 16c) that is optimal for that particular frequency.

As an example only, the system and method (10, 10′) may be provided as part of an in-vehicle remote control for a garage door, security gate, or the like. In that regard, communication circuit (14) may be a transmitter or transceiver for generating activation signals to be transmitted by antennas (16a, 16b, 16c) to a receiver in a GDO system (not shown).

More specifically, most GDO systems are being designed to operate using activation signals having one of six carrier frequencies: 288, 300, 310, 315, 318 or 390 MHz. Depending upon the particular carrier frequency utilized by a GDO system, one of the three antennas (16a, 16b, 16c) will be optimal for use in transmitting an activation signal. That is, a first antenna (16a) is provided for use in transmitting an activation signal having a carrier frequency of either 288 or 300 MHz. A second antenna (16b) is provided for use in transmitting an activation signal having a carrier frequency of 310, 315 or 318 MHz. A third antenna (16c) is provided for use in transmitting an activation signal having a carrier frequency of 390 MHz.

Thus, each of the antennas (16a, 16b, 16c) can be optimized for operation in one of a plurality of designated frequency bands, any one or more (or all) of which may be as narrow as a single or specific frequency (e.g., 390 MHz). That is, antennas (16a, 16b, 16c) need not be tunable and no tuning circuitry or components for such antennas (16a, 16b, 16c) are required. In addition, since all of the antennas (16a, 16b, 16c) are connected to communication circuit (14), either in series or in parallel, no switching circuitry or components are required. As previously described, any frequency presented to the input feedpoint (20) of antenna network (12) radiates out the antenna (16a, 16b, 16c) that is optimal for that particular frequency.

The plurality of frequency bands designated is based on those frequency bands or frequencies that may be utilized in various applications, such as RKE, TPM, remote control of GDO systems, vehicle immobilization, voice activated controls, and others. A controller (18) may be provided for determining or selecting a desired or required one of the plurality of designated frequency bands. Once again, although communication circuit (14) may be a transmitter or transceiver as discussed above, it may also or alternatively be a receiver depending upon the application selected.

As can also be seen, the method (10) comprises connecting communication circuit (14) to an antenna network (12), where the network comprises a plurality of antennas (16a, 16b, 16c), each antenna (16a, 16b, 16c) optimized for operation in one of a plurality of designated frequency bands. The antennas (16a, 16b, 16c) may be connected in series or in parallel. Communication circuit (14) may comprise a transmitter, receiver or transceiver, and any one or more (or all) of the designated frequency bands may be as narrow as a single frequency.

The method (10) may further comprise determining or selecting the one of the plurality of designated frequency bands required or desired. As noted above, the plurality of frequency bands designated is based on those frequency bands or frequencies that may be utilized in various applications, such as RKE, TPM, remote control of GDO systems, vehicle immobilization, voice activated controls, and others.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for use in wireless communication, the system comprising:
a communication circuit; and
an antenna network connected to the communication circuit, the network comprising a plurality of antennas, each antenna optimized for operation in one of a plurality of designated frequency bands.

2. The system of claim 1 wherein the communication circuit comprises a transceiver.

3. The system of claim 1 wherein the communication circuit comprises a transmitter.

4. The system of claim 1 wherein the communication circuit comprises a receiver.

5. The system of claim 2 wherein the transceiver is for use in an automotive application.

6. The system of claim 3 wherein the transmitter is for use in an automotive application.

7. The system of claim 4 wherein the receiver is for use in an automotive application.

8. The system of claim 1 wherein the plurality of antennas are connected in parallel.

9. The system of claim 1 wherein the plurality of antennas are connected in series.

10. The system of claim 1 wherein at least one of the plurality of designated frequency bands comprises a single frequency.

11. The system of claim 1 wherein each of the plurality of designated frequency bands comprises a single frequency.

12. A method for use in wireless communications, the method comprising:
connecting a communication circuit to an antenna network, the network comprising a plurality of antennas, each antenna optimized for operation in one of a plurality of designated frequency bands.

13. The method of claim 12 wherein the communication circuit comprises a transmitter.

14. The method of claim 12 wherein the communication circuit comprises a receiver.

15. The method of claim 12 wherein the communication circuit comprises a transceiver.

16. The method of claim 12 wherein at least one of the plurality of designated frequency bands comprises a single frequency.

17. The method of claim 12 wherein each of the plurality of designated frequency bands comprises a single frequency.

18. The method of claim 12 wherein the plurality of antennas are connected in parallel.

19. The method of claim 12 wherein the plurality of antennas are connected in series.

20. The method of claim 12 wherein the communication circuit is for use in an automotive application.
